(19) United States
(12) Patent Application Publication
(10) Pub. No.: US 2013/0306027 A1
(43) Pub. Date: Nov. 21, 2013

(54) Method for operating an internal combustion engine and control device for this

(71) Applicant: Robert Bosch GmbH, (US)

(72) Inventors: Aschraf Tobail, Stuttgart (DE); Juergen Hoenings, Waiblingen (DE); Oliver Heim, Schwieberdingen (DE)

(73) Assignee: Robert Bosch GmbH, Stuttgart (DE)

(21) Appl. No.: 13/673,687

(22) Filed: Nov. 9, 2012

(30) Foreign Application Priority Data
Nov. 10, 2011 (DE) 10 2011 086 063.0

(51) Int. Cl. F02D 45/00

(52) U.S. Cl. CPC F02D 45/00
USPC 123/349

(57) ABSTRACT

A method for operating an internal combustion engine is described, in which a setpoint torque for the operation of the internal combustion engine is specified, an actual torque delivered by the internal combustion engine being ascertained as a function of a signal of at least one cylinder pressure sensor, and a comparison between a variable that is a function of the setpoint torque and the actual torque being carried out.

### RELATED APPLICATION INFORMATION

The present application claims priority to and the benefit of German patent application no. 10 2011 086 063.0, which was filed in Germany on Nov. 10, 2011, the disclosure of which is incorporated herein by reference.

### FIELD OF THE INVENTION

The present invention relates to a method, a control and/or a regulating device for operating an internal combustion engine in which a setpoint torque is specified for the operation of the internal combustion engine.

### BACKGROUND INFORMATION

Control units of internal combustion engines for motor vehicles are believed to be available from the market, in which a setpoint torque is ascertained using a computer program, starting from a position of an accelerator pedal.

One published patent from this specialty field is European document EP 0 826 102 B1, for example.

### SUMMARY OF THE INVENTION

An object on which the exemplary embodiments and/or exemplary methods of the present invention is based is attained by a method according to the description herein as well as by a control and/or regulating device according to the alternative/further description herein. Advantageous refinements are indicated in the further descriptions herein.

The exemplary embodiments and/or exemplary methods of the present invention relate to a method for operating an internal combustion engine in which a setpoint torque is specified for the operation of the internal combustion engine. This takes place, for instance, by the driver of the motor vehicle operating an accelerator pedal with his foot. A position of the accelerator pedal is transmitted to a control and/or regulating device of the internal combustion engine and is evaluated there.

According to the exemplary embodiments and/or exemplary methods of the present invention, an actual torque delivered by the internal combustion engine is ascertained as a function of a signal of at least one cylinder pressure sensor, and a comparison is made between a quantity that is a function of the setpoint torque and the actual torque. As an alternative or in supplement, a knock sensor may also be used if appropriate. The quantity that is a function of the setpoint torque is, for instance, the sum of the setpoint torque and a so-called loss torque, which will be described in greater detail below. In one additional embodiment of the present invention, the quantity that is a function of the setpoint torque is a value range that is defined as a function of the setpoint torque or as a function of the sum of the setpoint torque and the loss torque. This is about a numerical or a percentage value range which is referred to the respective setpoint torque.

The setpoint torque is virtual, and is specified, whereas the actual torque is real and is ascertained as a function of a signal of the cylinder pressure sensor. This signal may be an electric voltage or a numerical quantity, and in the control and/or regulating device there accordingly takes place, for instance, a comparison of an electric voltage to an electric voltage, or rather a numerical quantity to a numerical quantity or other quantities that correspond to the torques (actual/setpoint torque) compared according to the exemplary embodiments and/or exemplary methods of the present invention. Electric voltages may be compared using analog circuits, such as using an integrator. The ascertaining of the torque from a signal curve of the cylinder pressure sensor is perhaps not reversible.

The at least one cylinder pressure sensor may record a curve over time of the gas pressure (“cylinder pressure curve”) in the respective combustion chamber, particularly during the compression stroke and/or the power stroke. A respective actual torque delivered by the internal combustion engine may then be ascertained by known methods from the curve over time. The cylinder pressure may be recorded several times during a power stroke of the internal combustion engine, for instance by digital scanning. On the scanning values, suitable numerical operations may be applied in each case to ascertain the actual torque. In the same way, it is possible, for example, to integrate the cylinder-pressure curve, particularly during the power stroke, which may perhaps take place even using an analog circuit.

The exemplary embodiments and/or exemplary methods of the present invention have the advantage that the ascertainment of a fuel quantity, to be injected into a respected cylinder or combustion chamber, is able to be monitored in a comparatively simple and yet precise manner. This monitoring takes place essentially by using the actual torque of the internal combustion engine (“inner torque”), which is ascertained from the signal of the at least one cylinder pressure sensor. In particular, the monitoring may take place while doing without quantities which characterize an actuation or opening time point and/or closing time point of a fuel injector. The operation of the internal combustion engine may be simplified thereby and costs may be saved. Furthermore, the structure of a computer program ascertaining and monitoring the fuel quantity to be injected at the same time may be simplified. An expenditure for changes, adjustments and/or further developments of the computer program may also be reduced.

The exemplary embodiments and/or exemplary methods of the present invention may be particularly useful if it is used for checking and/or correcting the operation of internal combustion engine and/or of a control and/or regulating device that is controlling the internal combustion engine. Thereby possible inaccuracies or errors, which, starting from the position of the accelerator pedal, influence the ascertainment of the fuel quantity to be injected, and with that the drive of the internal combustion engine, may be compensated for and/or avoided. This brings about safety technology advantages, especially during operation of a motor vehicle.

The method works more accurately if the actual torque is ascertained individually for each cylinder, for in this case, each cylinder of the internal combustion engine has at least one cylinder pressure sensor, by the use of which the cylinder pressure curve, that is, the curve over time of the gas pressure prevailing in the combustion chamber is ascertained. Thereby deviations or errors of individual cylinders may be adjusted, whereby the operation of internal combustion engine may be further improved.

One embodiment of the method provides that, when a difference between the actual torque and the setpoint torque or the quantity that is a function of the setpoint torque is greater than a threshold value, one may conclude that there has been an error. The error may, for example, be a physical error of a cylinder or of the associated fuel injector. It may also be an error in recording the position of the accelerator pedal or other quantities used for ascertaining the fuel quantity that is to be injected. The error may also be of the control and/or regulating device or of the computer program running on it. Or it may be an error of the cylinder pressure sensor, which will be described in greater detail below. When an error has been detected, a signal may be triggered, for instance, for the information of the driver and/or an entry may be made in an error memory of a diagnostic device of the internal combustion engine. The operation of internal combustion engine or the motor vehicles is thereby made safer.

The exemplary embodiments and/or exemplary methods of the present invention may particularly provide that the control of the internal combustion engine using a computer program takes place, the computer program including at least one first and one second region which are functionally separate from each other, in the first region, a fuel quantity to be introduced into the combustion chamber of the internal combustion engine being ascertained as a function of the setpoint torque, and in the second region, the monitoring of the results ascertained by the computer program of the first region taking place, the quantity that is a function of the setpoint torque being compared to the actual torque. Thus the ascertainment of the fuel quantity to be injected that takes place in the first region, from which the actual torque of the internal combustion engine comes about, is monitored by the second region.

This is of particular advantage in a motor vehicle, because it increases safety. The calculations carried out in the first region may also be carried out and monitored and or checked for plausibility in the second region, and there because of the functional separation of the regions advantageously using increased reliability, and possibly using additional quantities and parameters not used in the first region. For example, using the above, an undesired increase and/or an undesired reduction of the actual torque may be detected and perhaps be prevented. The operation of internal combustion engine or the motor vehicle is thereby clearly improved.

It should be understood that the method according to the present invention is not restricted to its execution using a computer program, but in any part may also be configured as an electronic circuit. The method may also, for example, be implemented totally or in part as an ASIC (application-specific integrated circuit) or as an FPGA (freely programmable digital circuit).

One embodiment of the method provides that a fuel quantity that is to be entered into the combustion chamber be ascertained while using an efficiency. The efficiency takes into account, for example, a position in time of the fuel quantity, that is to be injected into the combustion chamber, with regard to an angle of the crankshaft of internal combustion engine, as well a rotational speed of the crankshaft, and additional variables, if required.

The method is improved if the actual torque is directly compared to the variable that is a function of the setpoint torque, in such a way that one may conclude that there has been an error of one or more cylinder pressure sensors. Thus the signals of the cylinder pressure sensors may be regarded as being plausible, and suitable measures may be taken if necessary. This effectively raises the reliability of the method according to the present invention.

In supplement, it is provided that the at least one cylinder pressure sensor be monitored occasionally or periodically, by comparing the variable that is a function of the setpoint torque to the actual torque. For instance, one may conclude that there has been an error, of the at least one cylinder pressure sensor, if the result of the comparison satisfies at least one specifiable criterion, such as the exceeding of a threshold value for a specifiable time period. The monitoring of the cylinder pressure sensor may, for instance, also take place in the overrun condition of the internal combustion engine.

One defined operating state of the internal combustion engine is particularly suitable for valuing a respective cylinder pressure sensor with regard to the ascertained actual torque, and thus to monitor for “absolute” deviations.

As an additional supplement, it is provided that the at least two cylinder pressure sensors be monitored occasionally or periodically by comparing them relative to each other. Thmay be also takes place in a specified operating state of the internal combustion engine. Thereby the cylinder pressure sensors are also able to be monitored for “relative” deviations from each other. This takes place particularly by a comparison of the electrical signals that are present at the cylinder pressure sensors or rather are provided by them. The at least two cylinder pressure sensors may be situated in the same combustion chamber of the internal combustion engine, but may be in a respectively different one.

An additional embodiment of the method provides that the actual torque be ascertained in the second region of the computer program and, in supplement, be used in the first region, a fuel quantity to be entered into the combustion chamber of the internal combustion engine being corrected. Thereby the operation of the internal combustion engine is able to be improved, and possible errors may be compensated for or prevented, as explained above.

Furthermore, the exemplary embodiments and/or exemplary methods of the present invention include a control and/or regulating device for an internal combustion engine, using which, a setpoint torque for the operation of the internal combustion engine is able to be specified, the control and/or regulating device being developed to ascertain an actual torque delivered by the internal combustion engine as a function of a signal of at least one cylinder pressure sensor, it being further developed to carry out a comparison between a variable'that is a function of the setpoint torque and the actual torque.

Important features for the exemplary embodiments and/or exemplary methods of the present invention are also found in the following drawings and in the description of the drawings, the features being able to be important for the exemplary embodiments and/or exemplary methods of the present invention both alone and also in different combinations, without further explicit reference being made to it.

Exemplary specific embodiments of the present invention are elucidated in greater detail below, with reference to the appended drawings.

### BRIEF DESCRIPTION OF THE DRAWINGS

FIG. 1 shows a simplified schematic representation of an internal combustion engine.

FIG. 2 shows a block diagram for a method for operating the internal combustion engine.

FIG. 3 shows a flow chart of the method.

### DETAILED DESCRIPTION

The same reference numerals are used, even in different specific embodiments, for functionally equivalent elements and variables in all the figures.

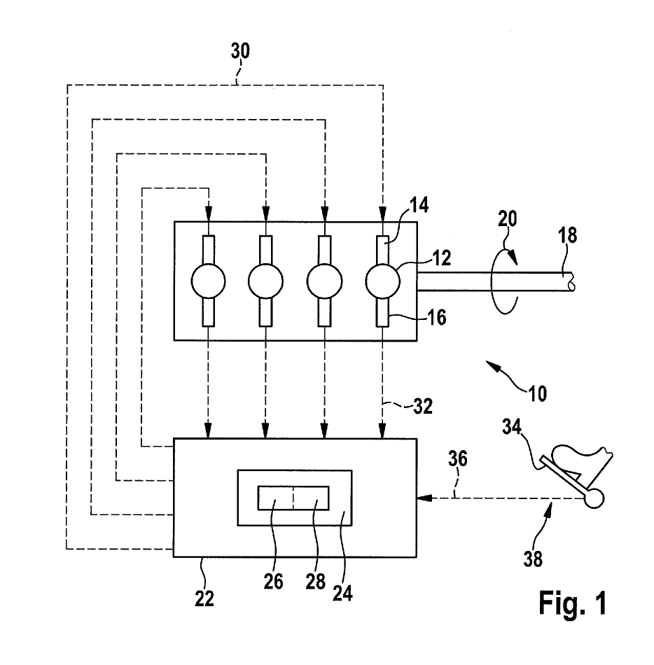

FIG. 1 shows a greatly simplified schematic representation of an internal combustion engine 10 having four cylinders 12 of a motor vehicle that is not shown. Each of cylinders 12 has a fuel injector 14, by which fuel is able to be injected from a high-pressure reservoir that is not shown. In the present instance, each cylinder 12 additionally has a cylinder pressure sensor 16, by which the gas pressure in cylinder 12 is able to be ascertained during operation of internal combustion engine 10. For the sake of clarity, the respective reference numerals are given only for cylinder 12, that is at the right in the drawing. Each of cylinders 12 has a combustion chamber (not having a reference numeral), in which fuel for driving internal combustion engine 10 is able to be burned. Moreover, internal combustion engine 10 includes a crankshaft 18, which rotates at a rotational speed 20.

In the drawing, under internal combustion engine 10 a control and/or regulating device 22 is shown, which includes a computer program 24. Among other things, computer program 24 has a first region 26 and a second region 28, which are functionally separated from each other. Control and/or regulating device 22 is connected using outgoing electric lines 30 to fuel injectors 14, and using incoming electrical lines 32 to cylinder pressure sensors 18. Furthermore, an accelerator pedal 34 is shown, which is able to transmit its current position, using an electrical line 36, to control and/or regulating device 22.

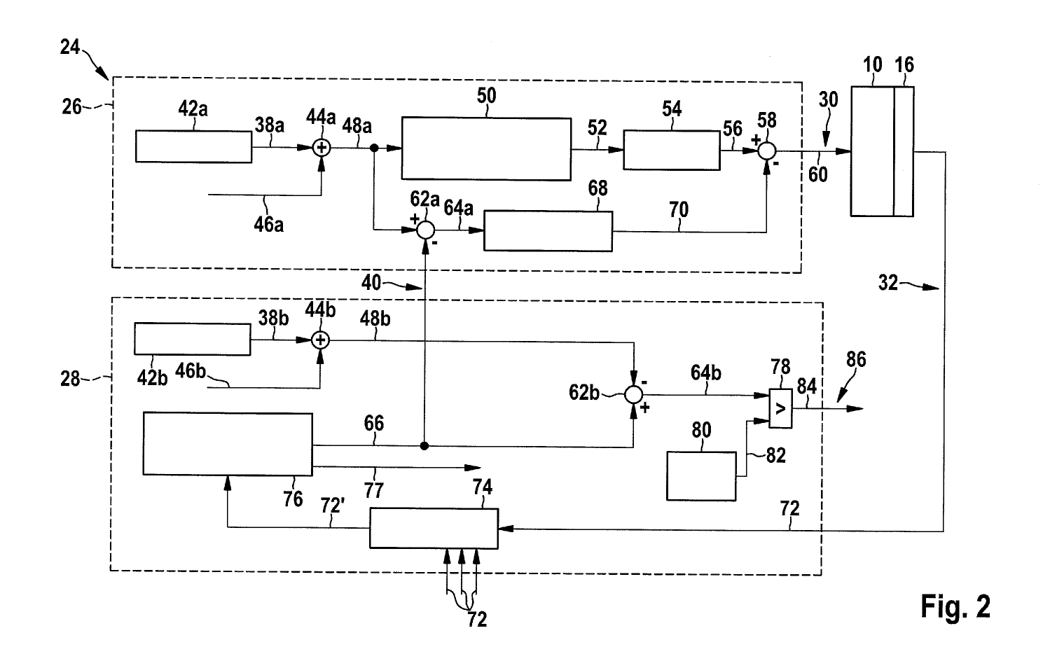

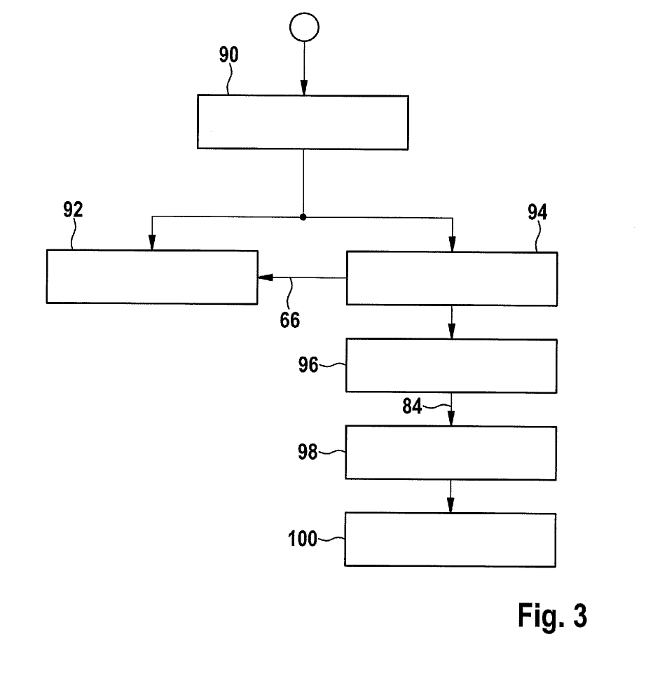

In the operation of internal combustion engine 10, accelerator pedal 34 is actuated by the driver of the motor vehicle, in order to request a respectively desired setpoint torque 38. In control and/or regulating device 22, a certain respective fuel quantity is ascertained from setpoint torque 38 using computer program 24, which, using fuel injectors 14, is to be, or is injected into cylinders 12. This will be explained in greater detail using subsequently described FIGS. 2 and 3.

FIG. 2 shows a block diagram on the operation of internal combustion engine 10, which in the drawing is shown at the top right. In an upper part of FIG. 2, using a dashed line, first region 26 is boxed in, and in a lower part, using a dashed line, second region 28 of computer program 24 is boxed in. First region 26 is functionally separated from second region 28, so that second region 28 is essentially able to work independently of first region 26. Via a connection 40, shown in the middle of the drawing, data from second region 28 is however able to be transmitted to first region 26.

In FIG. 2, a plurality of additional connections characterizes, corresponding to each arrow direction, a logical and/or numerical processing of the steps, shown using the blocks, of computer program 24. In the drawing, the processing takes place essentially from left to right. The representation of FIG. 2 may describe the individual control of each cylinder 12 respectively of internal combustion engine 10. The schematic representation shown in FIG. 2 applies correspondingly for the remaining cylinders 12.

In first region 26, in a block 42a, a setpoint torque 38a is ascertained and in a subsequent adder 44a is linked to a loss torque 46a. Loss torque 46a may be able to be ascertained using a characteristics map, and includes, for example, frictional losses of internal combustion engine 10, of a transmission and/or of the motor vehicle. A torque sum 48a, generated using adder 44a, thus corresponds to a setpoint value for an “inner torque” of internal combustion engine 10.

In a subsequent block 50, an efficiency 52 (“torque efficiency”) is ascertained. Efficiency 52 describes a relationship between an injected fuel quantity, or a duration of opening of fuel injector 14, and the associated drive torque generated by the combustion of the fuel. Efficiency 52 takes into account, in particular, a position in time of the fuel quantity, that is to be injected into the combustion chamber, with regard to an angle of the crankshaft 18 of internal combustion engine 10, as well as the rotational speed 20 of crankshaft 18, and additional variables, if required.

In an additional block 54 an injection quantity 56 is ascertained from efficiency 52 and as a function of the setpoint torque, which is to be injected into a respective cylinder 12. Injection quantity 56 is supplied to a subtractor 58 and is thus recalculated to a corrected injection quantity 60. A variable characterizing corrected injection quantity 60 is then used to actuate respective fuel injector 14 (FIG. 1).

An additional subtractor 62a forms a difference 64a from torque sum 48a and a current “inner torque” transmitted from second region 28, which will subsequently be designated as actual torque 66 of internal combustion engine 10. Difference 64a is supplied to a subsequent torque regulator 68, which ascertains from it quantity correction 70. Quantity correction 70 is supplied to the inverse input of subtractor 58.

In second region 28, in a block 42b, a setpoint torque 38b is ascertained and in a subsequent adder 44b is linked to a loss torque 46b, to form a torque sum 48b. Torque sum 48b is thus a variable that is a function of setpoint torque 38b. This applies correspondingly for torque sum 48a mentioned above.

A signal 72 of cylinder pressure sensor 16 is supplied to a signal evaluation 74, via electrical line 32. In supplement, signals 72 of the remaining cylinder pressure sensors 16 are also supplied to signal evaluation 74. In signal evaluation 74, signal 72, or rather signals 72 are evaluated with respect to their plausibility, and following from this, a diagnosis is derived for the associated cylinder pressure sensor 16. A signal 72′ at an output of signal evaluation 74 corresponds to signal 72, signal 72′ possibly being able to be corrected by a certain measure with respect to signal 72.

In a subsequent signal recording 76, a cylinder pressure is ascertained from signal 72′. The cylinder pressure is ascertained particularly in those phases in which the piston of respective cylinder 12 is currently transmitting a torque onto crankshaft 18. Furthermore, in signal recording 76 actual torque 66, which was mentioned, is ascertained from the ascertained cylinder pressure, and made available to further elements of the block diagram of FIG. 2. In supplement, signal recording 76 ascertains from signal 72′ one or more variables 77 which characterize combustion features of cylinder 12.

In a subtractor 62b, torque sum 48b and actual torque 66 are linked. This process is similar to the linkage in subtractor 62a of first region 26. A difference 64b at the output of subtractor 62b is compared in a comparator 78 to a threshold value 82 that is output by a block 80. Provided the difference 64b or an absolute amount of difference 64b is greater than threshold value 82, one may use result 84 at the output of comparator 78 to conclude that there has been an error 86. Error 86 relates particularly to an erroneous ascertainment of corrected injection quantity 60 in first region 26 of computer program 24. For instance, input parameters for region 26 may have been recorded or ascertained wrongly, or, for reasons of calculating time, in first region 26, simplified procedures may have been used which yield faulty results for, perhaps, not expected operating cases of internal combustion engine 10, or the like. The error may also be one of control and/or regulating device 22 or even an error of cylinder pressure sensor 16. Thereupon, for example, a signal for informing the driver may be triggered and/or an entry may be made in an error memory of a diagnostic device of internal combustion engine 10, and/or computer program 24 may carry out or trigger a measure for avoiding or remedying error 86.

Furthermore, one may recognize in FIG. 2 that actual torque 66 ascertained in signal recording 76 is also made available to first region 26 via connection 40, whereby, using subtractor 62a and subtractor 58, a correction of injection quantity 60 may take place. A computation check of additional quantity corrections, which have no influence on actual torque 66 (“inner torque”) of internal combustion engine 10, may be omitted according to the exemplary embodiments and/or exemplary methods of the present invention.

Since it is important, for the method according to the present invention, that cylinder pressure sensors 16 correctly ascertain the respective actual torque 66, these may be occasionally or periodically checked, using the schematic representation shown in FIG. 2. For one thing, cylinder pressure sensors 16 may be checked for plausibility in specified states among one another, and thus be monitored for a “relative” deviation. For another thing, actual torque 66 determined from the curve over time of the cylinder pressure, may be compared to setpoint torque 38, whereby cylinder pressure sensors 16 may be monitored for an “absolute” deviation. This takes place, for example, by using subtractor 62b, difference 64b being compared, if necessary, to an additional, second threshold value that is different from threshold value 82.

It should be understood that the signs shown in FIG. 2 at adders 44a and 44b as well as at subtractors 62a, 62b and 58 may also be determined to be different, as a function of a, perhaps even arbitrary, sign of the respective variables, to the extent that the effect intended by the exemplary embodiments and/or exemplary methods of the present invention is attained in each case.

The variables named in FIG. 2 using added subscripts “a” and “b” may be ascertained independently, as shown. In the case of an error-free operation of internal combustion engine 10 and its associated components, these are mostly similar to one another or even equal. For example, setpoint torques 38a and 38b are generally the same, and they then correspond to setpoint torque 36 of FIG. 1.

In one specific embodiment of the present invention that is not shown in the drawings, quantity 48a or 48b, that is a function of setpoint torque 38 (or 38a, 38b), is a value range that is defined as a function of setpoint torque 38. This is about a numerical or a percentage value range which is referred to respective setpoint torque 38, for example.

In supplement to FIG. 2, FIG. 3 shows a flow chart for carrying out a specific embodiment of the method according to the present invention. Beginning with a start block 90, in which the shown procedure begins, in a block 92, comparable to the corresponding step in first region 26 (FIG. 2) of computer program 24, setpoint torque 38a is ascertained from the signal emitted by accelerator pedal 34. As was described in FIG. 2, a (corrected) injection quantity 60 is ascertained from setpoint torque 38a.

In the same way, in a block 94 drawn in parallel, comparably to the corresponding step in second region 28 of computer program 24, setpoint torque 38b is ascertained and difference 64b is formed from actual torque 66. In addition, as was described above, actual torque 66 is transmitted to first region 26.

In a subsequent block 96, difference 64b is compared to threshold value 82. Result 84 is supplied to an error treatment 98, in which in each case suitable measures may be carried out for the minimization of possible error consequences. In a final block 100, the procedure shown in FIG. 3 ends.

What is claimed is:

1. A method for operating an internal combustion engine, the method comprising:
specifying a setpoint torque for the operation of the internal combustion engine;
ascertaining actual torque delivered by the internal combustion engine as a function of a signal of at least one cylinder pressure sensor; and
performing a comparison between a variable that is a function of the setpoint torque and the actual torque.

2. The method of claim 1, wherein a result of the comparison for at least one of checking and correcting the operation of at least one of the internal combustion engine, a control device and a regulating device, which is controlling the internal combustion engine, is used.

3. The method of claim 1, wherein the actual torque is ascertained individually for each cylinder.

4. The method of claim 1, wherein when a difference between the actual torque and the setpoint torque or the quantity that is a function of the setpoint torque is greater than a threshold value, it is concluded that there has been an error.

5. The method of claim 1, wherein the internal combustion engine is controlled by a computer program, which includes at least one first region and one second region, which are functionally separate from each other, wherein in the first region, a fuel quantity to be introduced into the combustion chamber of the internal combustion engine is ascertained as a function of the setpoint torque, wherein in the second region, a monitoring of the results, ascertained by the computer program, of the first region is performed, and wherein the variable that is a function of the setpoint torque is compared to the actual torque.

6. The method of claim 1, wherein a fuel quantity that is to be introduced into the combustion chamber is ascertained while using an efficiency.

7. The method of claim 1, wherein the at least one cylinder pressure sensor is monitored occasionally or periodically, by comparing the variable that is a function of the setpoint torque to the actual torque, it is concluded that there has been an error of the at least one cylinder pressure sensor if a result of the comparison satisfies at least one specifiable criterion.

8. The method of claim 1, wherein at least two cylinder pressure sensors are monitored occasionally or periodically by comparing them relative to each other.

9. The method of claim 7, wherein the comparison occurs in a specified operating state of the internal combustion engine.

10. The method of claim 5, wherein the actual torque is ascertained in the second region and used in supplement in the first region, and wherein a fuel quantity to be introduced into the combustion chamber of the internal combustion engine is corrected as a function of the actual torque.

11. A control and/or regulating device for an internal combustion engine, comprising:
a control and/or regulating arrangement configured to specify a setpoint torque for the operation of the internal combustion engine, to ascertain an actual torque delivered by the internal combustion engine as a function of a signal of at least one cylinder pressure sensor, and to perform a comparison between a variable that is a function of the setpoint torque and the actual torque.
